(19) United States
(12) Patent Application Publication
(10) Pub. No.: US 2014/0159841 A1
(43) Pub. Date: Jun. 12, 2014

(54) SOFT MAGNETIC CORE AND METHOD OF MANUFACTURING THE SAME

(71) Applicant: SAMSUNG ELECTRO-MECHANICS CO., LTD., Suwon (KR)

(72) Inventors: Hak Kwan KIM, Gyunggi-do (KR); Chang Ryul Jung, Gyunggi-do (KR); No II Park, Gyunggi-do (KR); Sung Yong An, Gyunggi-do (KR)

(73) Assignee: SAMSUNG ELECTRO-MECHANICS CO., LTD., Suwon (KR)

(21) Appl. No.: 13/770,933

(22) Filed: Feb. 19, 2013

(30) Foreign Application Priority Data
Dec. 12, 2012 (KR) 10-2012-0144649

(51) Int. Cl. H01F 41/02; H01F 3/08

(52) U.S. Cl. CPC H01F 41/0246; H01F 3/08
USPC 335/297; 419/61; 419/66

(57) ABSTRACT

There is provided a soft magnetic core including: a composite metal powder in which surfaces of iron (Fe) particles are coated with an insulating layer; a body part formed by compressing the composite metal powder; and an alloying element diffused from a surface of the body part to an inside thereof.

### CROSS-REFERENCE TO RELATED APPLICATIONS

This application claims the priority of Korean Patent Application No. 10-2012-0144649 filed on Dec. 12, 2012, in the Korean Intellectual Property Office, the disclosure of which is incorporated herein by reference.

### BACKGROUND OF THE INVENTION

1. Field of the Invention

The present invention relates to a soft magnetic core having excellent density characteristics and high efficiency, and a method of manufacturing the same.

2. Description of the Related Art

In general, a soft magnetic material may have various applications, such as in a core of an inductor or in components of an electric apparatus such as a motor, that is, a stator, a rotor, an actuator, a sensor, and a transformer core. According to the related art, as a method of manufacturing a soft magnetic core used as a component of the electric apparatus, a method of stacking several processed steel sheets and then fixing the stacked steel sheets to be integrated with each other has been used. However, in the case of manufacturing a soft magnetic core by stacking steel sheets, it may be difficult to manufacture a product having a complicated three-dimensional shape, and a large amount of off-cut scraps may be generated from the steel sheets.

Therefore, recently, a method of high-pressure molding of a soft magnetic powder has been introduced. In this method, a core having a high degree of freedom in view of a shape thereof may be manufactured. In this case, the soft magnetic powder used therein, a powder having magnetism when electricity is applied thereto, is formed of iron-based soft magnetic particles. When a soft magnetic core is manufactured using this soft magnetic powder, a general powder metallurgical process is used.

After an iron based soft magnetic material is prepared in a powder form by a spraying method, a grinding method, or the like, mechanical processing, a thermal treatment, and the like, are performed on the powder, such that soft magnetic powder capable of being appropriately used as a core material may be produced. The soft magnetic powder prepared as described above is press-molded, such that a soft magnetic core having a desired shape is formed.

According to the related art, in order to implement a low core-loss feature, an alloy powder has been used for the soft magnetic powder, but formability thereof has been deteriorated, and density of the formed soft magnetic core has been relatively low. Therefore, a soft magnetic core having high density and high efficiency while having excellent formability, and a method of manufacturing the same have been demanded.

Unlike the present invention, the following Patent Document 1 fails to disclose a method of manufacturing a soft magnetic core using powder.

### RELATED ART DOCUMENT

(Patent Document1) Korean Patent Laid-Open Publication No. 10-2011-0124392

### SUMMARY OF THE INVENTION

An aspect of the present invention provides a soft magnetic core having excellent density characteristics and high efficiency, and a method of manufacturing the same.

According to an aspect of the present invention, there is provided a soft magnetic core including: a composite metal powder in which surfaces of iron (Fe) particles are coated with an insulating layer; a body part formed by compressing the composite metal powder; and an alloying element diffused from a surface of the body part to an inside thereof.

The alloying element may include at least one of silicon (Si), aluminum (Al), chromium (Cr), molybdenum (Mo), and boron (B).

The composite metal powder may have an average particle diameter of 100 to 200 μm.

The insulating layer may have a thickness of 50 to 1000 nm.

The alloying element may be included in an iron (Fe) based alloy formed by diffusion of the alloying element at a concentration of 3.5 to 10 wt %.

The insulating layer may include a ceramic or an insulating resin. The ceramic may be at least one selected from a group consisting of a ferrite, a silicon oxide, a sodium silicate, and a magnesium oxide, and the insulating resin may include an epoxy resin.

According to another aspect of the present invention, there is provided a method of manufacturing a soft magnetic core, the method including: preparing a composite metal powder in which surfaces of iron (Fe) particles are coated with an insulating layer; preparing a slurry including the composite metal layer; manufacturing a body part to have a core shape using the slurry; applying an alloying element or a compound including the alloying element to a surface of the body part to form a coating layer; and diffusing the alloying element from the coating layer to an inside of the body part through heat treatment to form an iron (Fe) based alloy.

The alloying element may include at least one of silicon (Si), aluminum (Al), chromium (Cr), molybdenum (Mo), and boron (B).

The coating layer may have a thickness of 5 to 10 μm.

The composite metal powder may have an average particle diameter of 100 to 200 μm.

The insulating layer may have a thickness of 50 to 1000 nm.

The alloying element may be included in the iron (Fe) based alloy at a concentration of 3.5 to 10 wt %.

The insulating layer may include a ceramic or an insulating resin. The ceramic may be at least one selected from a group consisting of a ferrite, a silicon oxide, a sodium silicate, and a magnesium oxide, and the insulating resin may include an epoxy resin.

The manufacturing of the body part may be performed by press molding the slurry.

The heat treatment may be performed at 600° C. to 800° C.

The slurry may further include at least one of a binder and a lubricant.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart illustrating a method of manufacturing a soft magnetic core according to an embodiment of the present invention;

FIG. 2 is a process diagram illustrating a process of manufacturing the soft magnetic core according to the embodiment of the present invention; and

FIG. 3 is a process diagram illustrating operations S4 to S6 of FIG. 2 through cross-sectional views taken along line A-A′ of the products manufactured in respective operations.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

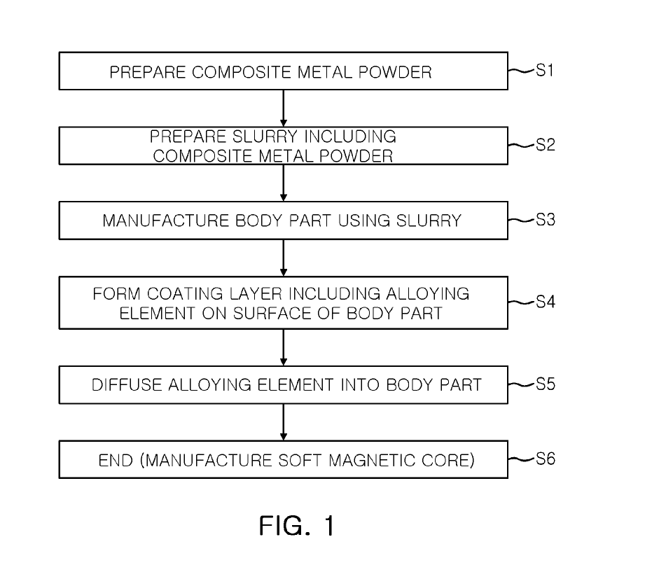

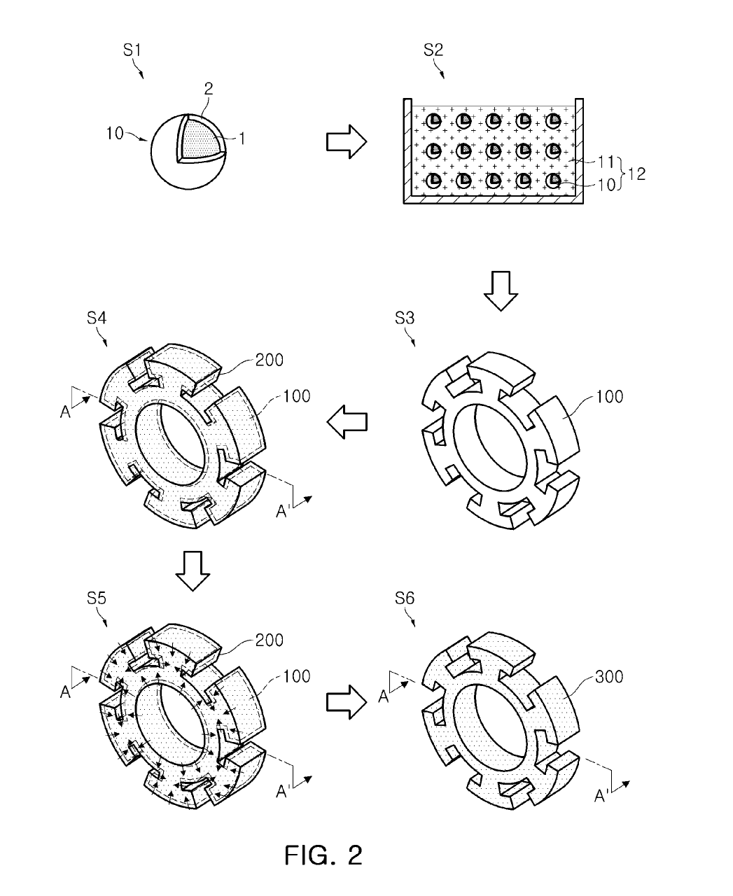

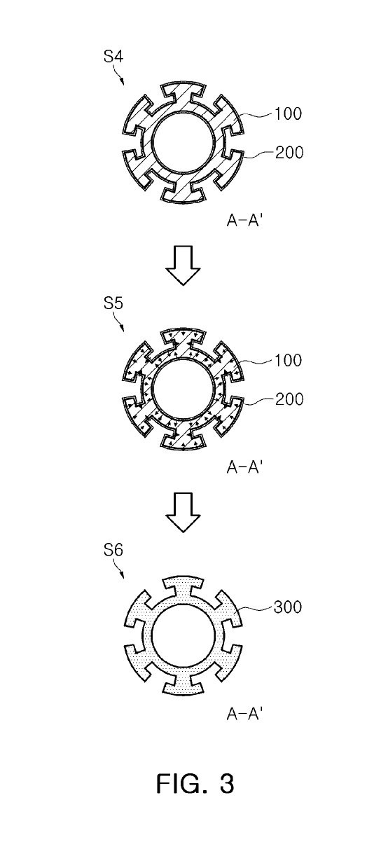

FIG. 1 is a flowchart illustrating a method of manufacturing a soft magnetic core according to an embodiment of the present invention. FIG. 2 is a process diagram illustrating a process of manufacturing the soft magnetic core according to the embodiment of the present invention, and FIG. 3 is a process diagram illustrating operations S4 to S6 of FIG. 2 through cross-sectional views taken along line A-A′ of the products manufactured in respective operations.

A method of manufacturing a soft magnetic core 300 according to an embodiment of the present invention may include preparing a composite metal powder 10; preparing a slurry 20 including the composite metal powder 10; manufacturing a body part 100 having a core shape using the slurry 20; forming a coating layer 200 including an alloying element on a surface of the body part 100; and diffusing the alloying element into the body part 100.

Hereinafter, respective operations will be described in detail.

(A) Preparing Composite Metal Powder

The composite metal powder 10, which is a basic material of the soft magnetic core 300 according to the embodiment of the present invention, may be prepared by coating an insulating layer 2 on surfaces of iron (Fe) particles 1. The iron (Fe) particles 1 may be preferably pure iron in order to implement formability of the body part 100. Although the term “pure iron” refers to iron that does not include impurities and has a purity of 100% in a strict sense, since it is difficult to completely remove impurities such as carbon, nitrogen, silicon, phosphorus, sulfur, or the like, included in pig iron, generally, the term “pure iron” is used to refer to iron having relatively higher purity than other irons. In the present invention, the term “pure iron” is used in a general sense.

The insulating layer 2 formed on the surface of the iron (Fe) particle 1 may be formed of ceramic or an insulating resin. The insulating layer 2 allows individual iron (Fe) particles 1 to be electrically isolated to thereby reduce eddy current loss. The insulating layer 2 may include the ceramic or the insulating resin, but is not particularly limited thereto.

The ceramic is not particularly limited, but may be at least one selected from a group consisting of a silicon oxide, a sodium silicate, and a magnesium oxide. In addition, an oxide having high resistance may be used.

Further, the insulating layer 2 may be formed of ferrite for excellent magnetic properties. In the present specification, the term “ferrite” collectively refers to magnetic ceramic including an iron oxide. Since the ferrite has magnetism and insulation, magnetic flux density of the manufactured core may be improved as compared to a case of using ceramic that does not have magnetism as the insulating layer.

In addition, the insulating resin may include an epoxy resin. The epoxy resin may be, for example, a phenol glycidyl ether type epoxy resin such as a phenol novolac type epoxy resin, a cresol novolac type epoxy resin, a naphthol modified novolac-type epoxy resin, a bisphenol A type epoxy resin, a bisphenol F-type epoxy resin, a biphenyl type epoxy resin, a triphenyl type epoxy resin, or the like; a dicyclopentadiene type epoxy resin having a dicyclopentadiene skeleton; a naphthalene type epoxy resin having a naphthalene skeleton; a dihydroxy benzopyran type epoxy resin; a glycidylamine type epoxy resin including polyamine such as diaminodiphenylmethane; a triphenylmethane type epoxy resin; a tetraphenylethane-type epoxy resin; and a mixture thereof, but is not particularly limited thereto.

An average particle diameter of the composite metal powder 10 may be 100 to 200 μm. In the case in which the average particle diameter of the composite metal powder 10 is smaller than 100 μm, the magnetic flux density of the manufactured core may be decreased. In the case in which the average particle diameter is larger than 200 μm, the magnetic flux density of the manufactured core may be increased, but core loss may be increased, and particularly, eddy current loss causing a problem at a high frequency may be rapidly increased. Therefore, the composite metal powder 10 may have the average particle diameter of 100 to 200 μm.

In addition, the insulating layer may have a thickness of 50 to 1000 nm. In the case in which the thickness of the insulating layer is greater than 1000 nm, the magnetic flux density may be decreased, and in the case in which the thickness of the insulating layer is less than 50 nm, a crack may be generated in the insulating layer at the time of press-molding to cause a tunneling effect, whereby an insulating effect may be decreased.

(b) Preparing Slurry

In this operation, the slurry 20 including the prepared composite metal powder 10 may be prepared. An additive 11 may be further included in addition to the composite metal powder 10, wherein the additive may include a binder, a solvent, a lubricant, or the like, but is not limited thereto.

The binder may be at least one selected from a group consisting of water glass, polyimide, polyamide, silicone, a phenol resin, and an acryl material, but is not limited thereto.

In addition, a volatile solvent may be added in order to adjust viscosity of the slurry 20. The volatile solvent may include at least one of toluene, alcohol, methyl ethyl ketone, but is not limited thereto.

Further, the slurry 20 may further include a lubricant. The lubricant may include liquid lubricating oil, semi-solid grease, solid lubricating oil, or the like, but is not limited thereto.

(C) Manufacturing Body Part

The body part 100 is manufactured using the slurry 20. In this case, a method of injecting the slurry 20 into a core shaped mold and then press-molding the injected slurry may be used, but the present invention is not limited thereto. That is, any method may be used as long as the composite metal powder 10 is agglomerated to manufacture a core in a bulk form.

(D) Forming Coating Layer on Surface of Body Part

The coating layer 200 including an alloying element may be formed on the surface of the manufactured body part 100. The alloying element is not particularly limited as long as the alloying element may increase electric resistance of the soft magnetic core 300 and may include at least one of silicon (Si), aluminum (Al), chromium (Cr), molybdenum (Mo), and boron (B).

Silicon (Si), aluminum (Al), chromium (Cr), molybdenum (Mo), and boron (B) has an excellent effect of increasing the resistance as compared with other alloying elements.

The coating layer 200 may include the alloying element and be formed in various shapes in a range in which the alloying element may be diffused.

For example, although not limited, the coating layer 200 may be formed of a pure substance containing only the alloying element or be formed of a compound including the alloying element.

A method of forming the coating layer 200 is not particularly limited as long as the alloying element may be uniformly applied. For example, a deposition method such as a physical vapor deposition (PVD) method, a chemical vapor deposition (CVD) method may be used, and a dipping-coating method may be used when the shape of the body part 100 is not excessively complicated.

The coating layer 200 may have a thickness of 5 to 10 μm. The alloying element included in the coating layer 200 may be diffused into the body part 100, and the thickness of the coating layer 200 and a diffusion amount of the alloying element may be in proportion to each other. In the case in which the diffusion amount of the alloying element is not controlled, a problem may be caused.

More specifically, in the case in which the thickness of the coating layer is greater than 10 μm, the diffusion amount of the alloying element mainly having non-magnetism may be significantly increased, and thus the magnetic flux density or permeability is decreased, and the manufactured soft magnetic core 300 has density of 7.6 g/cm³ or less, such that it may be difficult to apply the soft magnetic core 300 to a motor. Further, in the case in which the thickness of the coating layer 200 is less than 5 μm, the diffusion amount of the alloying element is decreased and the magnetic flux density or permeability is high, but core loss determining motor efficiency may exceed 40 W/kg, such that characteristics distinguished from the existing powder core may disappear. Therefore, in consideration of all of the core loss characteristics, the magnetic flux density, the permeability, and the density, the thickness of the coating layer 200 may be 5 to 10 μm.

(E) Diffusing Alloying Element

In this operation, an iron (Fe) based alloy is formed by diffusing the alloying element from the coating layer 200 formed on the surface of the body part 100 to the inside of the body part 100 through heat treatment. Through this operation, the pure iron (Fe) included in the body part 100 may be converted into an alloy having the alloying element at a predetermined concentration, whereby the soft magnetic core 300 to be desired may be finally obtained.

The heat treatment may be performed at 600° C. to 800° C.

An object of heat treatment at the time of manufacturing a general powder core is to remove residual stress generated due to press-molding, which may be achieved when the heat treatment is performed at 400° C. to 500° C. The reason is that when the residual stress remains, hysteresis loss may be increased, and finally core loss may be increased.

However, a heat treatment temperature may be 600° C. to 800° C. for diffusion of the alloying element, and a heat treatment time may be 15 minutes or less in order to significantly reduce damage to the insulating layer 2 of the composite metal powder 10.

Meanwhile, 3.5 to 10 wt % of the alloying element may be included in the iron (Fe) based alloy. The higher the content of the alloying element is, the larger the electric resistance is, and thus the core loss of the soft magnetic core 300 may be reduced. In order to have a core loss value of 40 W/kg or less, which is a core loss value of the existing powder core, the content of the alloying element should be 3.5 wt % or more. Further, in the case in which the content of the alloying element is more than 10 wt %, the content of the alloying element in the soft magnetic core 300 becomes high, and thus the magnetic flux density of the soft magnetic core 300 becomes 1.5 T or less, which is a threshold value in order to be used in the motor, and the density of the soft magnetic core 300 becomes 7.6 g/cm³ or less, whereby it may be difficult to apply the soft magnetic core 300 to the motor.

Therefore, the content of the alloying element included in the alloy made of iron (Fe)-alloying element may be 3.5 to 10 wt %.

According to another embodiment of the present invention, there is provided a soft magnetic core 300 including a composite metal powder 10 in which surfaces of iron (Fe) particles 1 are coated with an insulating layer 2; a body part 100 formed by compressing the composite metal powder 10; and an alloying element diffused from a surface of the body part 100 to the inside of the body part 100.

The alloying element may be at least one of silicon (Si), aluminum (Al), chromium (Cr), molybdenum (Mo), and boron (B).

An average particle diameter of the composite metal powder 10 may be 100 to 200 μm.

The alloying element may be included at a concentration of 3.5 to 10 wt % based on the iron (Fe) powder.

The insulating layer 2 may include a ceramic or an insulating resin, wherein the ceramic may be at least one selected from a group consisting of a ferrite, a silicon oxide, a sodium silicate, and a magnesium oxide, and the insulating resin may include an epoxy resin.

### EXAMPLES

The following Table 1 shows density, magnetic flux density, core loss values of the finally manufactured soft magnetic cores 300, according to the thickness of the coating layer 200 formed on the surface of the body part 100.

The coating layer 200 was formed by applying silicon (Si) to the surface of the body part 100, and the body part 100 was manufactured to have a core size of 3.5-inch hard disk drive (HDD).

TABLE 1

| Si-coating | | Magnetic Flux | Core Loss |
|---|---|---|---|
| Thickness (μm) | Density (g/cm³) | Density (T) at 10 KA/m | (W/kg) |
| 3* | 7.69 | 1.80 | 55 |
| 5 | 7.65 | 1.70 | 41 |
| 10 | 7.61 | 1.60 | 22 |
| 15* | 7.55 | 1.57 | 20 |
| 20* | 7.50 | 1.52 | 19 |
| 50* | 7.40 | 1.40 | 18 |
| 100* | 7.30 | 1.20 | 17 |

(*indicates Comparative Examples.)

As shown in Table 1, in the case in which the Si-coating thickness was 3 μm or less, the core loss value was 55 W/kg, and thus there was no difference with the existing powder core, and motor efficiency was reduced. Further, in the case in which the Si-coating thickness was 5 μm, the core loss value was 41 W/kg, similar to that of the existing powder core, but the density and the magnetic flux density were excellent, whereby the soft magnetic core 300 further improved than that in the related art may be obtained.

In addition, in the case in which the Si-coating thickness was more than 10 μm, the density was 7.6 g/cm³ or less, and the magnetic flux density was also 1.5 T or less, so that it may be difficult to apply the coating layer to the motor.

Therefore, according to the Inventive Examples, the thickness of the coating layer 200 may be 5 to 10 μm.

According to another embodiment of the present invention, there is provided a soft magnetic core 300 including a composite metal powder 10 in which surfaces of iron (Fe) particles 1 are coated with an insulating layer 2; a body part 100 formed by compressing the composite metal powder 10; and an alloying element diffused from a surface of the body part 100 to the inside of the body part 100 to thereby be dissolved as a solid solution in the iron (Fe) particles 1.

The alloying element may include at least one of silicon (Si), aluminum (Al), chromium (Cr), molybdenum (Mo), and boron (B), and the composite metal powder 10 may have an average particle diameter of 100 to 200 μm.

The alloying element may be included in an alloy formed by diffusion of the alloying element at a concentration of 3.5 to 10 wt %.

The insulating layer 2 may include a ceramic or an insulating resin, wherein the ceramic may be at least one selected from a group consisting of a silicon oxide, a sodium silicate, and a magnesium oxide, and the insulating resin may include an epoxy resin.

An overlapped description of features of the soft magnetic core 300 will be omitted.

In the method of manufacturing a soft magnetic core according to the embodiment of the present invention, since iron (Fe) configuring the composite metal powder 10 is pure iron, the formability may be further improved as compared with the case in which the core is manufactured using powder particles formed of an iron based alloy such as silicon steel according to the related art. The reason is that in the case of the iron based alloy including silicon, boron, or the like, brittleness may be higher than that of pure iron. Further, in the case of manufacturing the soft magnetic powder core using the iron based alloy, the powder particles may be damaged at the time of molding, and strength and saturation magnetic flux density may not be sufficiently high, and thus it may be difficult to use such a core in a small-sized motor such as a hard disk drive (HDD). However, according to the embodiment of the present invention, due to relatively high elasticity and excellent formability of pure iron, the manufactured soft magnetic core 300 may have excellent strength, density and saturation magnetic flux density.

Further, high resistance and low core loss characteristics may be implemented through diffusion of the alloying element after the body part 100 is formed, such that the soft magnetic core 300 having high efficiency may be provide.

Therefore, in the method of manufacturing a soft magnetic core according to the embodiment of the present invention and the soft magnetic core 300 manufactured thereby, improved formability in the case of using the iron based powder formed of pure iron and low core loss characteristics in the case of using the iron based alloy may be simultaneously implemented.

As set forth above, according to embodiments of the present invention, a soft magnetic core having excellent density characteristics and high efficiency, and a method of manufacturing the same may be provided.

While the present invention has been shown and described in connection with the embodiments, it will be apparent to those skilled in the art that modifications and variations can be made without departing from the spirit and scope of the invention as defined by the appended claims.

What is claimed is:

1. A soft magnetic core comprising:
a composite metal powder in which surfaces of iron (Fe) particles are coated with an insulating layer;
a body part formed by compressing the composite metal powder; and
an alloying element diffused from a surface of the body part to an inside thereof.

2. The soft magnetic core of claim 1, wherein the alloying element includes at least one of silicon (Si), aluminum (Al), chromium (Cr), molybdenum (Mo), and boron (B).

3. The soft magnetic core of claim 1, wherein the composite metal powder has an average particle diameter of 100 to 200 μm.

4. The soft magnetic core of claim 1, wherein the insulating layer has a thickness of 50 to 1000 nm.

5. The soft magnetic core of claim 1, wherein the alloying element is included in an iron (Fe) based alloy formed by diffusion of the alloying element at a concentration of 3.5 to 10 wt %.

6. The soft magnetic core of claim 1, wherein the insulating layer includes a ceramic or an insulating resin.

7. The soft magnetic core of claim 6, wherein the ceramic is at least one selected from a group consisting of a ferrite, a silicon oxide, a sodium silicate, and a magnesium oxide.

8. The soft magnetic core of claim 6, wherein the insulating resin includes an epoxy resin.

9. A method of manufacturing a soft magnetic core, the method comprising:
preparing a composite metal powder in which surfaces of iron (Fe) particles are coated with an insulating layer;
preparing a slurry including the composite metal layer;
manufacturing a body part to have a core shape using the slurry;
applying an alloying element or a compound including the alloying element to a surface of the body part to form a coating layer; and
diffusing the alloying element from the coating layer to an inside of the body part through heat treatment to form an iron (Fe) based alloy.

10. The method of claim 9, wherein the alloying element includes at least one of silicon (Si), aluminum (Al), chromium (Cr), molybdenum (Mo), and boron (B).

11. The method of claim 9, wherein the coating layer has a thickness of 5 to 10 μm.

12. The method of claim 9, wherein the composite metal powder has an average particle diameter of 100 to 200 μm.

13. The method of claim 9, wherein the insulating layer has a thickness of 50 to 1000 nm.

14. The method of claim 9, wherein the alloying element is included in the iron (Fe) based alloy at a concentration of 3.5 to 10 wt %.

15. The method of claim 9, wherein the manufacturing of the body part is performed by press molding the slurry.

16. The method of claim 9, wherein the heat treatment is performed at 600° C. to 800° C.

17. The method of claim 9, wherein the slurry further includes at least one of a binder and a lubricant.

18. The method of claim 9, wherein the insulating layer includes a ceramic or an insulating resin.

19. The method of claim 18, wherein the ceramic is at least one selected from a group consisting of a ferrite, a silicon oxide, a sodium silicate, and a magnesium oxide.

20. The method of claim 18, wherein the insulating resin includes an epoxy resin.
